(19) United States
(12) Patent Application Publication
(10) Pub. No.: US 2008/0003521 A1
(43) Pub. Date: Jan. 3, 2008

(54) Process and a device for creating a pattern in a photoresist layer

(76) Inventors: Klaus Elian, Bubenreuth (DE); Christoph Hohle, Bubenreuth (DE)

Correspondence Address: SLATER & MATSIL LLP, 17950 PRESTON ROAD, SUITE 1000, DALLAS, TX, 75252, US

(21) Appl. No.: 11/478,535

(22) Filed: Jun. 29, 2006

(51) Int. Cl. G03C 1/00

(52) U.S. Cl. 430/270.1

(57) ABSTRACT

In a process for creating a pattern in a photoresist layer, a photoresist layer is provided on a substrate. At least selected areas of the photoresist layer are exposed to a radiation beam thereby inducing a change in the chemical composition of the photoresist material in the selectively exposed areas of the photoresist layer. The exposed areas of the photoresist layer are thermally treated using a heated fluid. The photoresist layer is then developed thereby creating the pattern.

### TECHNICAL FIELD

Some embodiments of the invention are directed to a process for creating a pattern in a photoresist layer.

### BACKGROUND

Structure dimensions in photolithography are becoming increasingly smaller. In photolithography a photoresist is formed on a substrate to be structured. After the structuring of the photoresist the structure in the photoresist is transferred to the substrate. One of the problems of this photolithography process is to ensure that a high resolution structure can be formed in the photoresist layer.

### SUMMARY OF THE INVENTION

One embodiment of the invention describes a process for creating a pattern in a photoresist layer. A photoresist layer is provided on a substrate. At least selected areas of the photoresist layer are exposed to a radiation beam thereby inducing a change in the chemical composition of the photoresist material in the selectively exposed areas of the photoresist layer. The exposed areas of the photoresist layer are thermally treated using a heated fluid. The photoresist layer is then developed thereby creating the pattern.

The inventors found that by thermally treating the exposed areas of the photoresist layer using a heated fluid, a pattern with a higher resolution can be formed in the photoresist layer in comparison to conventional photolithography techniques. In particular the inventors found that by thermally treating the exposed areas of the photoresist layer with a heated liquid, this often so-called “post exposure bake” allows high resolutions to be achieved in the photoresist layer in comparison to, e.g., a treatment using heated gases, for example, air.

In contrast to gases like air, which are difficult to be kept at a certain temperature due to their low temperature conductivity, fluids have a higher temperature capacity. Therefore, the exposed areas of the photoresist layer can more easily be thermally treated by using a heated fluid than, for example, by using heated gases like air.

The denoting of the different steps of the process for creating a pattern does not imply a certain sequence of the method steps to be carried out.

In a further embodiment of the invention the above mentioned of exposing and thermally treating are carried out simultaneously. Such a variant of the process of the invention can reduce, for example, the time used to thermally treat the already-exposed areas of the photoresist layer and can, therefore, further increase the resolution of the pattern created in the photoresist layer.

In a further variant of the process of the invention the selected areas of the photoresist layer are exposed to the radiation through the heated fluid. Such a method, for example, can also increase the resolution of the pattern in the photoresist layer created by this process due to the fact that fluids often have a higher refractive index than, for example, gases as, e.g., air. This can allow radiation beams, which normally would be internally reflected at an interface between the device used to expose the photoresist layer and air, to contribute to the pattern created in the photoresist layer.

Methods wherein the photoresist layer is exposed through fluids are, for example, so-called “immersion lithography” techniques.

In yet another embodiment of the process of the invention, the heated fluid is selected from water and organic solvents. These fluids normally have a high refractive index. For example, perfluorinated polyethers can be used as organic solvents. In the case that the above-mentioned immersion lithography is used, it might be advantageous to use deionized water as the heated fluid.

In some variants of the process of the invention an exposure device, for example a so-called “stepper” or “scanner” can be used at least during the exposing step of the method of the invention. These exposure devices might, for example, comprise optical lens systems for interacting with radiation beams emitted from radiation sources, a mask holder for holding a mask that includes the pattern to be transferred to the photoresist layer and a substrate holder for example a so-called “waver stage” supposed to hold the substrate and the photoresist layer to be patterned.

In the case that immersion lithography is used during one variant of the process of the invention the heated fluid is preferably arranged between the last optical element of the exposure device, for example a lens and the photoresist layer to be patterned. Such an arrangement is able to avoid a large step in refractive index at the interface between the last optical element of the exposure device and the outside environment of this device. More preferably the heated fluid is in direct contact with the exposure device, e.g., the last lens of the optical lens system of that device and the photoresist layer to be exposed. Such an arrangement of the exposure device, the heated fluid and the photoresist layer provides a high resolution patterning process.

If an exposure device is used, for example a stepper or a scanner, it might be further advantageous that at least parts of the exposure device are heated. This might further increase the resolution of the process of the invention by reducing optical instabilities that might be introduced into the optical system of the exposure device by using a heated fluid. Preferably, at least the parts of the exposure device around the substrate and the heated fluid are kept at a higher temperature than the rest of the exposure device in order to reduce these instabilities. For example, in the case that the thermal treating step is carried out at a temperature around 95° C., it might be advantageous to heat at least parts of the exposure device to temperatures below the thermal treatment temperature, for example around 75° C.

In yet another embodiment of the process of the invention, a device for exposure might be used that is able to correct radiation beam errors or other errors, e.g., alignment errors that might be introduced into the exposure process by the heated fluid. Such a correction, for example, can be software based. In the case that a computer system for controlling the exposure device is used, this computer system might, for example, include software for temperature correction within the system. Such a system for a temperature correction might be able to take the radiation beam errors into consideration. For example, a system for correction of these errors can include a test exposure of a cold photoresist layer to be structured on a cold substrate through a heated immersion fluid, thereby evaluating all the errors introduced by the hot immersion fluid. The errors observed in the system in the exposure test and integration of these errors into a software for aligning and focusing the optical system in the exposure device, for example, the scanner, are processed. Due to the implementation of the observed errors into the alignment and focus correction software of the system of the exposure device, future exposure processes using the heated fluid can be corrected according to the observed errors thereby increasing the resolution of the process. If necessary it might be additionally possible to correct the design of the mask or the reticle that includes the pattern to be transferred to the photoresist layer. For example, it might be possible to implement the additional corrections in the design of the pattern on the mask during the adaption of the mask pattern due to optical proximity correction (OPC correction). Additionally, it might be possible to take the time effects concerning the heating of the exposure device into consideration. At the beginning of the exposure process the parts of the exposure device, which are near to or which are in direct contact with the heated fluid, are at the same temperature as the other components of the device, but are subsequently heated up during the exposure process. Therefore, it might be possible to use software for controlling the exposure device including a time dependent correction procedure that takes the slowly heating up of parts of the device into consideration.

In an further embodiment of the process of the invention a chemically amplified photoresist layer is provided, which is then exposed to a radiation beam in the exposure step of the method of the invention. During the exposure of a chemically amplified resist, for example, using an electron beam or UV beam, acids are released from the chemically amplified resists (for example, via radiation induced decomposition of so-called “photoacid generators”) inducing a change in the chemical composition of the photoresist material exposed. For example, the acids can render parts of the photoresist layer more soluble to aqueous mediums, for example, alkaline aqueous developer solutions, which are often used for developing the photoresist layer.

The acid released upon exposure in the chemically amplified photoresist layer can, for example, induce a change in the chemical composition of the photoresist material by an acid catalyzed cleavage of protection groups in the polymers of the photoresist material thereby increasing the solubility of the modified photoresist material in aqueous developer solutions (positive photoresist) or can, for example, induce chemical reactions rendering the exposed parts of the photoresist layer insoluble to an aqueous solution, for example, by acid catalyzed polymerization reactions (negative photoresist).

The inventors found that after the exposure of such chemically amplified photoresist layers, the acids released upon exposure start to diffuse within the photoresist layer thereby reducing the resolution of the patterning process. The advantage of this embodiment of the present invention is that due to the thermal treatment of the exposed areas of the chemically amplified photoresist layer with the heated fluid, the diffusion time of the acids released can be kept short so that a patterning process can be carried out resulting in higher resolution of the patterns created in the photoresist layer.

In yet another embodiment of the process of the invention, the thermal treatment takes around 5 to 30 seconds, preferably between 5 to 10 seconds. These short thermal treatment times) can normally ensure that a good resolution is achieved in the patterning process.

In a further variant of the process of the invention, the thermal treatment) is carried out at temperatures between 70° C. to 140°, preferably 90° C. to 100° C. These temperatures are especially suited to provide a good thermal treatment of the already-exposed areas of the photoresist layer.

In a further embodiment of the process of the invention, the heated fluid is exchanged during the thermal treatment). Due to the exchanging of the heated fluid, it might be easier to ensure that the heated fluid is kept at a constant high temperature.

In the case that the heated fluid is arranged between the areas of the photoresist layer to be exposed and the last optical element of an exposure device used to expose the photoresist layer during an immersion lithography process, exchanging the heated fluid can advantageously remove by-products of the exposure process, which might be released from the exposed areas of the photoresist layer away from these exposed areas, thereby favoring the thermal treating reaction within the exposed areas of the photoresist layer.

In a further embodiment of the process of the invention it might be possible that the heated fluid is constantly exchanged during the exposure and/or thermal treatment steps by using a device for exposure including a supplying system for applying the fluid to the photoresist layer to be exposed and also comprising a system for removing the fluid from the substrate and the photoresist layer. These systems can, for example, comprise nozzles or showerheads applying the heated fluid onto the photoresist layer and furthermore might comprise, e.g., suction pipes to remove the heated fluid. Such a constant exchange of the heated fluid has the advantage that reaction products or by-products of the exposure of the photoresist layer, which might be released into the hot fluid, can easily be removed by exchanging the heated fluid. These exposure by-products might otherwise interfere with the radiation beams used to expose the photoresist layer.

In a further variant of the process of the invention, the selected areas of the photoresist layer are exposed to a first fluid different from the heated, second fluid.

It is possible that both the first and the second fluids comprise the same fluid, but that just the second fluid is heated, whereas the first fluid is kept at the same temperature as the whole exposure system, for example at room temperature. No or fewer errors might be introduced into the optical system of the exposure device due to the fact that the first, non-heated fluid but not the second, heated fluid interacts with parts of the device and the radiation beam used to expose parts of the photoresist layer. Such an embodiment of the process might not comprise correction means for correcting temperature-induced errors, for example software-based correction means implemented in the computer system controlling the exposure device.

It is also possible that the first and second fluids comprise different fluids, for example water and organic solvents.

A further embodiment of the invention discloses a process for creating a pattern in a photoresist layer. A photoresist layer is provided on a substrate. At least selected areas of the photoresist layer are exposed to a radiation beam thereby inducing a change in the chemical composition of the photoresist material in the selectively exposed areas of the photoresist layer. Simultaneously, the exposed areas of the photoresist layer are thermally treated. The photoresist layer is then developed thereby creating the pattern.

Due to the fact that the exposure step and the thermal treatment step are carried out simultaneously in the same process step, the time used for thermally treating the exposed areas of the photoresist layer can be reduced, thereby increasing the resolution of the pattern created in the photoresist layer. For example, it might be possible in some variants of the process of this invention to form a pattern of less than 50 nm resolution.

In another variant of the process of the invention the exposed areas of the photoresist layer are thermally treated using a heated fluid. As already mentioned above, the thermal treatment involving a heated fluid has certain advantages, as, for example, that due to the high heat capacity of a fluid compared to a gas it is much easier to thermally treat a photoresist layer using a heated fluid instead of using a heated gas.

A further embodiment of the invention discloses a process for creating a pattern in a photoresist layer. A photoresist layer is provided on a substrate. At least selected areas of the photoresist layer are exposed to a radiation beam through a first fluid thereby inducing a change in the chemical composition of the photoresist material in the selectively exposed areas of the photoresist layer. The exposed areas of the photoresist layer are thermally treated using a second heated fluid. The photoresist layer is then developed thereby creating the pattern.

Such a process for creating a pattern can have the advantage that just the second fluid used to thermally treat the exposed areas of the photoresist layer is heated. In contrast, the first fluid used to selectively expose areas of the photoresist layer to a radiation beam is maintained at a temperature similar to the rest of the exposure device, thereby reducing the impact of the heat of the second fluid on the optical system of the exposure device.

In a further variant of the process of the invention, it might be useful that the first fluid is arranged between the optical lens system of the device used for exposure and the photoresist layer, preferably that the first fluid is in direct contact with the lens system of the exposure device and the photoresist layer. Such a method can for example comprise “immersion lithography” techniques that can further reduce the resolution of the pattern created by the process of the invention.

In a further variant of the method of the invention, the exposure device and the substrate including the photoresist layer to be patterned are moved relative to each other between the exposure and thermal treatment steps. Such a process for example can ensure that the first fluid is transported away from the exposed areas of the photoresist layer and that, for example, the second, heated fluid can now be brought in contact with these already exposed areas of the photoresist in order to provide the thermal treatment for these areas.

The step of developing the photoresist layer thereby creating the pattern can for example comprise applying an aqueous solution to the photoresist layer, wherein the exposed and the non-exposed areas of the photoresist layer have a different solubility in that aqueous solution. This solution can, for example, comprise an alkaline aqueous developer solution.

After the pattern has been created in the photoresist layer this pattern can be transferred to the substrate, for example, by using etching methods, for example, dry or wet etching methods. The substrate can, e.g., comprise a semiconductor substrate, for example, a silicon wafer. Integrated circuits can be formed on such a wafer using the different embodiments of the process according to the invention. Other options for a substrate include, but are not limited to a group consisting of sapphire, metal and glass.

The subject matter of a further variant of the invention includes a device. An optical lens system is able to interact with radiation emitted by a radiation emitting source. The system also includes a substrate holder and a supplying system for applying a fluid to a substrate to be held by the substrate holder. A heater heats the fluid.

Such a device can, for example, be used as an exposure device for carrying out different embodiments of the process of the invention. The heater might be used for heating the fluid, which can then be used for thermally treating the photoresist layer.

A heater for heating the fluid might, for example, comprise a thermostat used to heat up a container for storing the fluid.

In further variants of a device of the invention, the device might further include a casing enclosing at least the substrate holder, wherein the heater is able to heat the casing.

One advantage of such a device might be that the substrate holder can also be heated so that a constant high temperature can be maintained within the casing. Such a high temperature within the casing might further assist a thermal treatment of the photoresist layer using the heated fluid in different embodiments of a process according to the invention.

It might further be advantageous that the casing is thermally isolated from the other components of the device. Such a configuration can, for example, confine the high temperature to the interior of the casing so that all the other parts of the device can, for example, be kept at a different temperature, for example, room temperature, so that the heated part of the device does not interfere with the exposure process.

In another variant of the invention, the device might further include a cooling system for cooling the substrate held by the substrate holder. Such a cooling system can be advantageous where the substrate holder is enclosed by a casing heated up by a heater. Such a configuration might be able to keep the substrate itself at a temperature lower than the temperature surrounding the substrate within the casing.

It might further be advantageous that the device includes a container for storing the fluid wherein the heater is able to heat the container. In such a case the fluid can be heated up before being supplied to the substrate or to the photoresist layer located on the substrate.

Further additional embodiments of the device of the invention might include a radiation emitting source able to emit a radiation beam, wherein the optical lens system is arranged in the radiation path of the radiation emitting source.

The radiation emitting source might, for example, be an electron emitting radiation source, or laser devices emitting light in, e.g., the deep UV-range.

Further embodiments of the device of the invention might include a system for removing the fluid from the substrate to be held by the substrate holder. Such a system can, for example, include a suction pipe. Another example might be a ring structure located between the last lens element of the optical lens system of the exposure device and the photoresist layer located on the substrate. This ring structure might be able to confine the fluid to a certain area on the photoresist layer and might include openings for supplying and removing the fluid. For example, a first arrangement of openings might be located in the upper part of the ring structure for supplying the fluid, whereas a second arrangement of openings might be located in a lower part of the ring structure for removing the fluid or vice versa. A configuration including a combination of a supplying system for applying the fluid to the substrate and a system for removing the fluid from the substrate can, for example, provide a constant exchange of the fluid.

Some devices of the invention might include a correction system for correcting errors introduced by the heating of the fluid into the device. Such a correction system might for example, include a software-based correction system, for example, implemented in a computer system controlling the device.

The subject matter of a device according to another embodiment of the invention includes an optical lens system that is able to interact with radiation emitted by a radiation-emitting source and a substrate holder. A first supplying system applies a first fluid to a substrate to be held by the substrate holder. A second supplying system applies a second fluid to the substrate to be held by the substrate holder. A heater is provided for heating the second fluid.

Such a device can, for example, be used in an “immersion lithography” process for exposing a photoresist layer located on the substrate through the first fluid and then thermally treating the exposed areas of the photoresist layer by using the second fluid.

The first and second supplying systems might be able to transport the first and second fluid, respectively to different areas of the photoresist layer, so that different areas can be brought in contact with the first and second fluid at the same time. For example, it might be possible that in one step a particular area of the photoresist layer is exposed through the first fluid to a radiation beam and at the same time another area of the photoresist layer, which was already exposed to radiation is thermally treated using the second fluid.

The device might further comprise systems for removing the first and second fluids from the substrate to be held by the substrate holder. Such a configuration of systems for applying first and second fluids and systems for removing the respective first and second fluids can enable a constant exchange of the fluids during the exposure processes.

It might be further advantageous that the first and second supplying systems are thermally isolated from each other. Due to this thermal isolation the heat of the second fluid inside the second supplying system cannot easily be transferred to the first supplying system for the first fluid and can, therefore, not directly interfere with the exposure process.

Embodiments of different processes and devices according to the invention are now explained in more detail using schematic cross-sectional drawings and an example.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 shows a schematic cross-sectional view of one variant of a device of the invention during operation; and

FIG. 2 shows a cross-sectional schematic view of another embodiment of a device according to the invention during operation.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

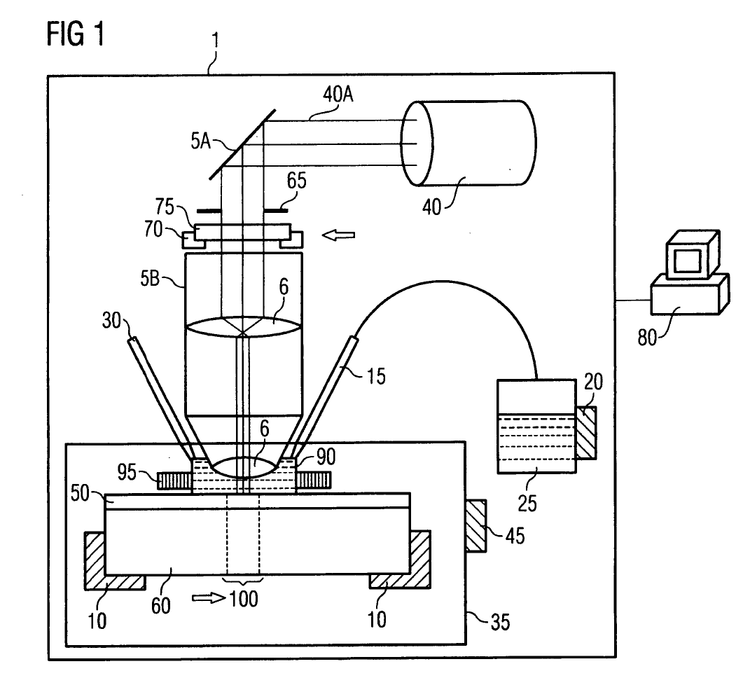

FIG. 1 depicts a schematic cross-sectional view of a device 1, for example a stepper or a scanner during operation. The device 1 is enclosed by a large container including a radiation emitting source 40 for example a laser, an optical lens system 5 comprising, for example, illumination optics 5A and projection optics 5B, including lenses 6. The radiation beams 40A emitted by the radiation emitting source 40 are directed via the illumination optics 5A through a slit 65 onto a mask 75 located on a mask holder 70. This mask includes a pattern to be transferred to a photoresist layer 50 located on a substrate 60. The radiation beams 40A passed through the mask 75 are further focused by the lenses 6 of the projection optics 5B.

When using immersion lithography a fluid 90 is brought in direct contact with the last lens 6 of the projection optics system 5B and the photoresist layer 50 to be patterned. This fluid 90 can, for example, comprise deionized water or other organic solvents having a high refractive index thereby reducing the fraction of radiation beams totally reflected at the interface of the last lens 6 to the fluid 90. The fluid 90 can constantly be provided and removed by a combination of a supplying system 15 applying the fluid 90 onto the photoresist layer 50 and a system 30 for removing the fluid 90.

The systems 15 and 30 can, for example, comprise showerheads or nozzles and suction pipes. The system 15 for applying the fluid 90 onto the photoresist layer 50 is further connected to a storage container 25 for storing the liquid 90. This container can be heated by a heater 20 to the desired temperature for thermally treating the exposed areas of the photoresist layer. The fluid 90 is furthermore confined by a ring 95 restricting the area of the fluid 90 to the area that is actually exposed by the device 1.

The radiation beams 40A are directed to an area 100 on the photoresist layer 50 that is exposed to the radiation and is simultaneously thermally treated using the heated fluid 90. Therefore, the process steps of exposing the photoresist layer to a radiation beam and thermally treating the exposed areas of the photoresist layer are carried out simultaneously. Afterwards the substrate 60 with the photoresist layer 50 can be moved relative to the optical lens system 5A, 5B and the mask 75 with the mask holder 70 so that different areas of the photoresist layer can be exposed to the radiation beams 40A.

An additional temperature control of the fluid 90 can be provided by enclosing the arrangement of the substrate 60 held by the substrate holder 10 and the photoresist layer 50 located on the substrate 60 in a casing 35, which is furthermore heated by a heater 45. In the case that the substrate 60 has to be kept at a temperature lower than the temperature within the heated casing 35 it might be furthermore advantageous to provide a cooling system for the substrate 60 (not shown in FIG. 1).

The arrows in FIG. 1 indicate the direction of movement of the substrate 60 and the photoresist layer 50 in relation to the direction of movement of the mask 75. Due to the relative movement of the mask 75 to the photoresist layer 50 on the substrate 60 and the optical lens system of the device, different areas 100 on the photoresist layer can be exposed with different patterns depending on the pattern on the mask 75.

The device 1 can furthermore comprise a computer system 80 for controlling the device. Such a computer system can for example include software for the temperature correction of the, e.g., optical lens system in order to reduce a potential negative impact of the high temperature of the fluid 90 on the exposing process.

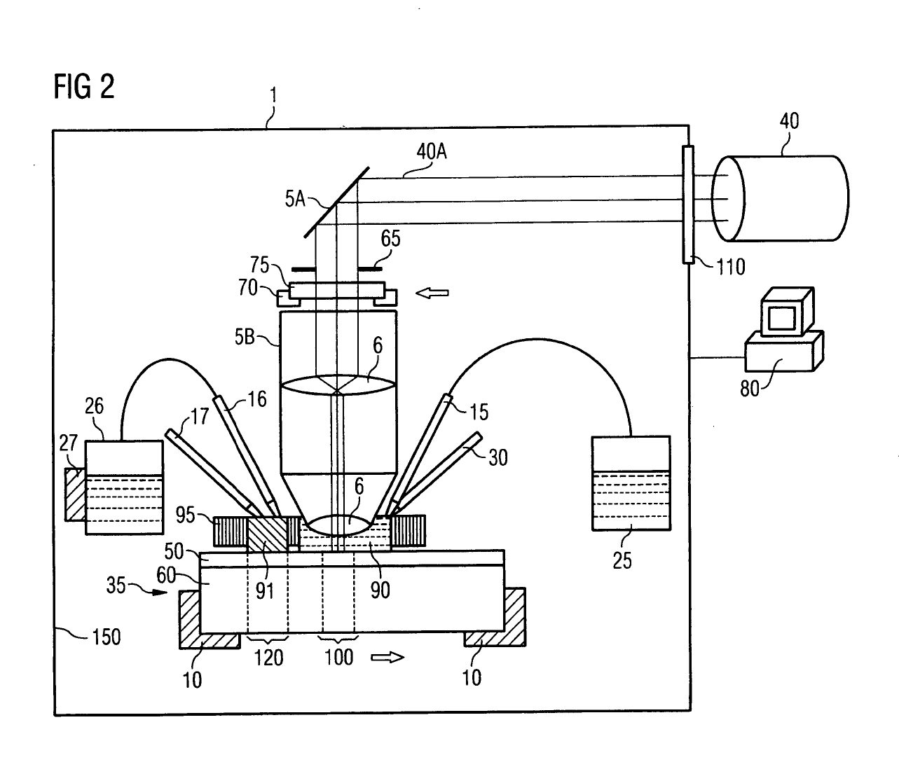

FIG. 2 shows another embodiment of a device of the invention in cross-sectional view during operation. The same reference numerals as in FIG. 1 also denote the same elements in FIG. 2.

In contrast to the device of FIG. 1, the device of FIG. 2 does not include the radiation emitting source 40 within the large housing 150, but rather couples the radiation beams 40A emitted by the radiation emitting source 40 into the interior of the housing via a coupling element 110. Furthermore, in contrast to the device of FIG. 1, the device of FIG. 2 uses a first fluid 90 and a second heated fluid 91 during the immersion lithography process. In this case a combination of a first system 15 for applying the first fluid 90 onto the photoresist layer 50 and a first system 30 for removing the first fluid 90 is part of the device. Furthermore, a combination of a second system 16 for applying the second heated fluid 91 onto the photoresist layer 50 and a second system 17 for removing the second heated fluid 91 is present. The second system 16 is connected to a storage container 26 for storing the second heated fluid 91, which can be heated by a heater 27. Again a ring structure 95 is present confining the first fluid 90 and the second, heated fluid 91 to certain areas of the photoresist layer 50.

During such an immersion lithography process, immersion lithography can take place via exposure of the areas 100 of the photoresist layer to radiation beams 40A through the first liquid 90. This liquid 90 is preferably kept at the same temperature as the rest of the device especially the optical lens system 5. Such a configuration enables a good exposure process without major impacts of a heated fluid on the exposure process. Furthermore, this device configuration allows the process steps of exposing the photoresist layer to a radiation beam and thermally treating the exposed areas of the photoresist layer to be carried out in different steps using different fluids 90 and 91.

The second heated fluid 91 can be used to thermally treat the areas 120 of the photoresist layer 50, which were already exposed to the radiation beams 40A during an earlier exposure step. For example, a movement of the substrate 60 and the photoresist layer 50 located on the substrate 60 relative to the other components of the device 1 (indicated by the arrows) makes it possible to bring the first heated fluid 91 in contact with different areas 120, 100 of the photoresist layer.

### EXAMPLE

A chemically amplified positive photoresist material is mixed containing:

93.6 g 1-methoxy-2-propylacetate as a solvent,

6.0 g of a terpolymer including 22.5 mol % tert.-butylmethacrylate, 50 mol % maleic acid anhydride, 22.5 mol % allylsilane and 5 mol % ethoxyethylmethacrylate,

0.35 g of triphenylsulfonium-hexafluoropropansulfonate as a photoacid generator, and

0.05 g trioctylamine as a basic additive.

The positive photoresist material was applied onto six silicone wafers using spin-coating (2000 rpm/20 s) and then dried on a hotplate for 90 seconds at a temperature of 140° C. The solvent evaporated resulting in a photoresist film of a thickness of 206 nm.

Subsequently the wafers with the photoresist films were exposed with a dose of, e.g., 25.3 mJ/cm² with a deep UV mask aligner (MJB 3 of Karl Suess GmbH) using a 248 nm filter through a grey scale mask (exposure time 316 seconds).

The wafers were then developed with an aqueous alkaline developer TMA 238 WA (purchased from JSR), washed with water for 30 seconds, dried with compressed air and baked by 110° C. for 60 seconds or 5 seconds.

Afterwards the resulting photoresist patterns on each wafer were measured and “contrast curves” recorded. These curves clearly show that a post exposure bake (PEB) time of 5 seconds also should be sufficient to develop a chemically amplified resist layer. This finding clearly shows that short PEP times provided by a heated fluid are sufficient for a chemically amplified resist layer.

Variants of the method of the invention can be used to form patterns with resolutions of lower than 50 nm in the exposed photoresist layer.

The scope of the protection of the invention is not limited to the example given herein above. The invention is embodied in each novel characteristic and each combination of characteristics, which particularly includes every combination of any features that are stated in the claims, even if this feature or this combination of features is not explicitly stated in the claims or in the examples.

What is claimed is:

1. A method for creating a pattern in a photoresist layer, the method comprising:
providing a photoresist layer over a substrate;
exposing at least selected areas of the photoresist layer to a radiation beam thereby inducing a change in the chemical composition of the photoresist material in the selectively exposed areas of the photoresist layer;
thermally treating the exposed areas of the photoresist layer using a heated fluid; and
developing the photoresist layer thereby creating the pattern.

2. The method according to claim 1, wherein the exposing and the thermally treating are carried out simultaneously.

3. The method according to claim 2, wherein the selected areas of the photoresist layer are exposed to the radiation beam through the heated fluid.

4. The method according to claim 1, wherein the heated fluid comprises water and/or organic solvents.

5. The method according to claim 1, wherein the exposing is performed using an exposure device.

6. The method according to claim 5, wherein at least parts of the exposure device are heated.

7. The method according to claim 6, wherein the parts of the exposure device are heated to a temperature that is about the same temperature as the heated fluid.

8. The method according to claim 3, wherein the exposing is performed using an exposure device that is able to correct radiation beam errors introduced by the heated fluid.

9. The method according to claim 3, wherein the exposing is performed using an exposure device that is in direct contact with the heated fluid.

10. The method according to claim 1, wherein providing a photoresist layer comprises providing a chemically amplified photoresist layer.

11. The method according to claim 1, wherein thermally treating the exposed areas comprises thermally treating for between about 5 and about 30 seconds.

12. The method according to claim 1, wherein thermally treating the exposed areas comprises thermally treating from between about 70° C. to about 140° C.

13. The method according to claim 1, wherein the heated fluid is exchanged during the exposing and thermally treating steps.

14. The method according to claim 1, wherein, during the exposing, the selected areas of the photoresist layer are exposed through a first fluid different from the heated, second fluid.

15. A method for creating a pattern in a photoresist layer, the method comprising:
providing a photoresist layer over a substrate;
exposing at least selected areas of the photoresist layer to a radiation beam thereby inducing a change in the chemical composition of the photoresist material in the selectively exposed areas of the photoresist layer, and simultaneously thermally treating the exposed areas of the photoresist layer; and
developing the photoresist layer thereby creating the pattern.

16. The method according to claim 15, wherein the exposed areas of the photoresist layer are thermally treated using a heated fluid.

17. The method according to claim 16, wherein exposing selected areas of the photoresist layer comprises exposing through the heated fluid.

18. A method for creating a pattern in a photoresist layer, the method comprising:
providing a photoresist layer over a substrate;
exposing at least selected areas of the photoresist layer to a radiation beam through a first fluid thereby inducing a change in the chemical composition of the photoresist material in the selectively exposed areas of the photoresist layer;
thermally treating the exposed areas of the photoresist layer using a second heated fluid; and
developing the photoresist layer thereby creating the pattern.

19. The method according to claim 18, wherein the first and second fluids are selected from the group consisting of water and organic solvents.

20. The process according to claim 18, wherein exposing at least selected areas of the photoresist layer comprises using an exposure device that includes an optical lens system able to direct the radiation beam to the exposed areas of the photoresist layer, the first fluid being arranged between the optical lens system and the photoresist layer.

21. The process according to claim 20, further comprising moving the exposure device and the substrate relative to each other between the exposing and thermally treating steps.

22. A device comprising:
a substrate holder;
an optical lens system able to interact with radiation emitted by a radiation emitting source, the optical lens system arranged to direct radiation toward the substrate holder;
a supplying system for applying a fluid to a substrate to be held by the substrate holder; and
a heater for heating the fluid.

23. The device according to claim 22, further comprising a casing enclosing at least the substrate holder, wherein the heater is able to heat the casing.

24. The device according to claim 23, wherein the casing is thermally isolated from other components of the device.

25. The device according to claim 23, further comprising a cooling system for cooling the substrate to be held by the substrate holder.

26. The device according to claim 22, further comprising a container for storing the fluid, wherein the heater is able to heat the container.

27. The device according to claim 22, further comprising a radiation emitting source, the optical lens system arranged in a radiation path of the radiation emitting source.

28. The device according to claim 22, further comprising a system for removing the fluid from the substrate to be held by the substrate holder.

29. The device according to claim 22, further comprising a correction system for correcting errors introduced by the heating of the fluid in the optical lens system.

30. A device comprising:
a substrate holder; and
an optical lens system able to interact with radiation emitted by a radiation emitting source, the optical lens system arranged to direct the radiation toward the substrate holder;
a first supplying system for applying a first fluid to a substrate to be held by the substrate holder;
a second supplying system for applying a second fluid to the substrate to be held by the substrate holder; and
a heater for heating the second fluid.

31. The device according to claim 30, further comprising a system for removing the first and second fluids from the substrate to be held by the substrate holder.

32. The device according to claim 30, wherein the first and second supplying systems are thermally isolated from each other.
